(19) United States
(12) Patent Application Publication
(10) Pub. No.: US 2005/0088988 A1
(43) Pub. Date: Apr. 28, 2005

(54) Method and system for controlling data rate of reverse link in a mobile communication system

(75) Inventors: Hwan-Joon Kwon, Suwon-si (KR); Jung-Soo Jung, Seoul (KR); Dong-Hee Kim, Yongin-si (KR); Youn-Sun Kim, Seongnam-si (KR); Jin-Kyu Han, Suwon-si (KR); Youn-Hyoung Heo, Suwon-si (KR); Ju-Ho Lee, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/964,443

(22) Filed: Oct. 13, 2004

(30) Foreign Application Priority Data
Oct. 28, 2003 (KR) 75674/2003
Aug. 10, 2004 (KR) 82978/2004

(51) Int. Cl. H04Q 7/00

(52) U.S. Cl. 370/328

(57) ABSTRACT

A mobile station determines a data rate in a mobile communication system including a plurality of base stations communicating with the mobile station. The mobile station receives rate control information from the base stations, and receives precedence indicator information from one of the base stations. The precedence indicator information is used for giving precedence to particular rate control information in the rate control information received from the base stations. The mobile station determines a data rate according to the particular rate control information to which precedence is given by the precedence indicator information.

### PRIORITY

This application claims priority under 35 U.S.C. § 119 to an application entitled “Method and System for Controlling Data Rate of Reverse Link in a Mobile Communication System” filed in the Korean Intellectual Property Office on Oct. 28, 2003 and assigned Serial No. 2003-75674, and an application entitled “Method and System for Controlling Data Rate of Reverse Link in a Mobile Communication System” filed in the Korean Intellectual Property Office on Aug. 10, 2004 and assigned Serial No. 2004-62978, the contents of both of which are incorporated herein by reference.

### BACKGROUND OF THE INVENTION

1. Field of the Invention

The present invention relates generally to a method and system for controlling a data rate in a mobile communication system, and in particular, to a method and system for controlling a data rate of a reverse link.

2. Description of the Related Art

A mobile communication system, which initially provided a voice service, has developed into a system capable of transmitting data at low speed. In order to meet user's increasing demands for improved services along with the rapid progress of mobile communication technology, the mobile communication system is evolving into an advanced system capable of transmitting data at higher speed with increased data transmission efficiency.

In the mobile communication system, transmission in a direction from a base station to a mobile station is called a “forward direction,” and transmission in a direction from a mobile station to a base station is called a “reverse direction.” A description will now be made of transmission of data in the reverse direction, and in particular, for a reverse data rate.

In a general mobile communication system, reverse data is transmitted over a packet data channel in packets of a physical layer. A data rate of each packet of the physical layer is variable, and is generally controlled by a base station. That is, one base station controls data rates of several mobile stations located in its coverage area.

Generally, a process of determining and controlling data rates of mobile stations by a base station is called “scheduling.” In the scheduling process, a base station determines data rates of mobile stations using information fed back from the mobile stations. The information fed back from the mobile stations includes information on available power of the mobile stations and the amount of data to be transmitted by the mobile stations. A scheduler of the base station performs scheduling considering Rise-of-Thermal (RoT) or a load acquired from a received signal-to-noise ratio (SNR) from a mobile station belonging to a current base transceiver station (BTS), in addition to the feedback information.

A technique in which a base station controls a reverse data rate of a mobile station is divided into a “full-rate transition” technique and a “limited-rate transition” technique according to transition frequency of a reverse data rate of the mobile station.

The full-rate transition technique does not restrict transition of a data rate in controlling a reverse data rate of a mobile station by a base station. A detailed description of the full-rate transition technique will now be made herein below.

In the full-rate transition technique, the base station can select one of all available data rates without considering a data rate at which the mobile station currently transmits packet data, in determining a data rate at which the mobile station will transmit the next packet. It will be assumed that a set of data rates available to a mobile station includes 9.6 Kbps, 19.2 Kbps, 38.4 Kbps, 76.8 Kbps, 153.6 Kbps, and 307.2 Kbps. Further, it will be assumed that the mobile station currently transmits packet data at a data rate of 9.6 Kbps. In this case, even though a current data rate of the mobile station is 9.6 Kbps, the base station using the full-rate transition technique can allow the mobile station to immediately change a data rate for the next packet to 307.2 Kbps. That is, in the full-rate transition technique, a reverse data rate of the mobile station allowable by the base station is not restricted to a previous data rate of the mobile station, and the step (or scope) of a change in data rate is also not restricted.

Next, a description of the limited-rate transition technique will be made. In the limited-rate transition technique, a base station restricts the scope of a change in data rate of a packet in determining a data rate for the next packet of a mobile station. For example, the base station limits an increase or decrease in data rate from the previous data rate to the next data rate, to one step increments. It will also be assumed that a set of data rates available to a mobile station includes 9.6 Kbps, 19.2 Kbps, 38.4 Kbps, 76.8 Kbps, 153.6 Kbps, and 307.2 Kbps. Further, it will be assumed that the mobile station currently transmits packet data at a data rate of 76.8 Kbps.

In this case, the base station using the limited-rate transition technique limits a data rate for the next packet of the mobile station to one of 38.4 Kbps, 76.8 Kbps and 153.6 Kbps. That is, the base station increases or decreases a next data rate from the current data rate by one step, or holds the current data rate of 76.8 Kbps. In other words, the limited-rate transition technique limits the scope of a change in data rate of the mobile station from the current data rate to the next data rate, to one step increments. In the limited-rate transition technique, one-step increase, one-step decrease, and current-rate hold commands are defined as Up, Down and Hold commands, respectively, and are signaling-mapped to ‘+1’, ‘−1’ and ‘0’ before being transmitted, respectively.

The base station schedules a reverse data rate based on the full-rate transition technique or the limited-rate transition technique, and transmits the scheduling result to the mobile station, to thereby control a reverse data rate for packet data of the mobile station. A method for transmitting the scheduling result information to the mobile station is implemented differently for the full-rate transition technique and the limited-rate transition technique. The full-rate transition technique is chiefly used for a method of allowing only a particular mobile station to perform reverse transmission only at a particular data rate. Therefore, in the full-rate transition technique, the base station must transmit information indicating the particular data rate together with information indicating a mobile station, which will transmit reverse packet data at the data rate. Therefore, as the number of available data rates in a rate set becomes larger, the amount of information to be transmitted also becomes larger.

The limited-rate transition technique can be divided into the following two methods. In a first method, a base station can send an Up, Down or Hold command for a data rate to all mobile stations located in its coverage area. In a second method, the base station can send an Up, Down or Hold command for a data rate only to a particular mobile station located in its coverage area. In the first method of the limited-rate transition technique, the base station uses only one or two kinds of information in controlling reverse data rates of all of its mobile stations. However, compared with the full-rate transition technique, the second method of the limited-rate transition technique is advantageous in that it can slightly reduce the amount of information transmitted over a forward channel.

A description will now be made of the strengths and weaknesses of the full-rate transition technique and the limited-rate transition technique.

The full-rate transition technique is advantageous in that transition of a data rate is not limited in determining a data rate for reverse packet data of a mobile station. However, the full-rate transition technique requires many bits in transmitting the scheduling result to a mobile station by a base station. For example, if there are 6 available data rates as stated above, 3 bits are required to express all of the data rates. Further, in the full-rate transition technique, in order to transmit information on a granted data rate to a particular mobile station, the base station transmits an identifier (ID) such as MAC ID (Medium Access Control ID) uniquely assigned to each mobile station together with the information on the granted data rate, causing an increase in the amount of transmission information. In the full-rate transition technique, a change in data rate of a particular mobile station is considerable, and the considerable change in data rate causes an abrupt change in interference to other mobile stations or a neighbor cell. Therefore, a change in channel conditions of mobile stations located in other cells becomes considerable, thereby exerting a bad influence on the system.

The limited-rate transition technique transmits the scheduling result with only one bit in controlling a data rate of reverse packet data. Therefore, the limited-rate transition technique has a small overhead. In addition, because the limited-rate transition technique limits a scope of a change in data rate of a mobile station to one step, a change in interference to other rate sets is relatively insignificant. However, in the limited-rate transition technique, because the base station changes a data rate of the mobile station on a step-by-step basis, it cannot support fast transition of the data rate.

In certain systems, a base station can control a traffic-to-pilot power ratio (TPR) of a mobile station, instead of controlling a data rate of the mobile station. In a typical mobile communication system, a base station controls power of a mobile station while controlling a data rate for reverse packet data. The power control process will now be described. If a mobile station receives a power control command from a base station, it controls power of its pilot channel by itself and controls power of other channels except the pilot channel using a fixed value of the TPR. For example, if the TPR is 3 dB, it means that a ratio of power of a traffic channel to power of a pilot channel transmitted by the mobile station is 2:1. Therefore, the mobile station determines a power gain of the traffic channel such that power of the traffic channel becomes two times the power of the pilot channel. In this manner, the mobile station also controls a ratio of gains of other channels to a gain of the pilot channel based on the fixed TPR value.

In the system which controls the TPR of a mobile station instead of controlling a data rate of the mobile station, a base station, after performing scheduling for determining a reverse data rate, transmits the TPR to the mobile station instead of transmitting information on the scheduled data rate. The TPR is characterized in that its value becomes larger as the data rate becomes higher. For example, doubling of a data rate is equivalent to approximately doubling the power assigned to a traffic channel by a mobile station. Therefore, it can be considered that the TPR value is doubled.

In some cases, however, a mobile station in a handoff state may simultaneously receive rate control information from several base stations. In this case, if the base stations use different rate transition techniques, as described above, the mobile station receives rate control information based on the different rate transition techniques from the base stations. Then the mobile station must select a rate transition technique, on which it must determine a data rate for reverse packet data.

In this case, if the mobile station selects one of the rate transition techniques without any criterion or if the mobile station selects one of the rate transition techniques based on different criteria to determine a data rate for reverse packet data, the data transmission may fail.

If it is assumed that a particular mobile station is in a handoff state and base stations included in an active set of the mobile station transmit reverse rate control information based on different rate transition techniques, then the mobile station in a handoff state may receive reverse rate control information based on different rate transition techniques from the base stations. For example, if it is assumed that one base station grants the mobile station a data rate of 153.6 Kbps for reverse packet and another base station grants the mobile station a data rate of 76.8 Kbps for reverse packet, if the mobile station transmits packet data at the data rate of 153.6 Kbps, the base station that granted the mobile station the data rate of 76.8 Kbps has a higher-than-expected load, causing an overload. However, if the mobile station transmits packet data at the data rate of 76.8 Kbps, transmission reliability thereof increases but the mobile station has low throughput. In addition, the base station that granted the mobile station the data rate of 153.6 Kbps cannot efficiently use a reverse load, because it is rather efficient that the base station grants the mobile station only the data rate of 76.8 Kbps and grants other mobile stations a higher data rate.

Moreover, if the mobile station in a handoff state must determine a data rate based on different rate transition techniques used by base stations, the mobile station must decide whether it should select the current reverse data rate or the granted data rate. Therefore, there is a demand for a method for clearly indicating a data rate to be selected in a mobile station when the mobile station is in a handoff state and receives different data rate information from base stations, or receives rate control information based on different rate transition techniques from the base stations.

### SUMMARY OF THE INVENTION

It is, therefore, an object of the present invention to provide a method and system for controlling a reverse data rate of a mobile station in a handoff state.

It is another object of the present invention to provide a method and system for determining a reverse data rate by a mobile station in a handoff state using received different rate control information.

It is further another object of the present invention to provide a method and system for determining a reverse data rate by a mobile station in a handoff state according to received rate control information based on different rate transition techniques.

It is yet another object of the present invention to provide a method and system for previously transmitting rate control information by a base station through a signaling message so that a mobile station in a handoff state can determine its data rate.

To achieve the above and other objects, there is provided a method for determining a data rate by a mobile station in a mobile communication system including a plurality of base stations communicating with the mobile station. The method includes receiving rate control information from the base stations; receiving precedence indicator information from one of the base stations, wherein the precedence indicator information is information for giving precedence to particular rate control information in the rate control information received from the base stations; and determining a data rate according to the particular rate control information to which precedence is given by the precedence indicator information.

To achieve the above and other objects, there is provided a mobile communication system for determining a reverse data rate. The system includes a plurality of base stations for transmitting rate control information according to a scheduling result; and at least one mobile station for receiving the rate control information transmitted from the base stations, and determining its data arte according to precedence indicator information set in the rate control information, wherein the precedence indicator information is information for giving precedence to particular rate control information in the rate control information received from the base stations.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a configuration of a mobile communication system to which the present invention is applied;

FIG. 2 is a flowchart illustrating a procedure for determining a reverse data rate by a mobile station in a handoff state according to a first embodiment of the present invention;

FIG. 3 is a flowchart illustrating a method for determining a reverse data rate of a mobile station according to a second embodiment of the present invention; and

FIG. 4 is a flowchart illustrating a method for determining a reverse data rate of a mobile station in a handoff state according to a third embodiment of the present invention.

### DETAILED DESCRIPTION OF THE PREFERRED EMBODIMENT

Several preferred embodiments of the present invention will now be described in detail with reference to the annexed drawings. In the following description, a detailed description of known functions and configurations incorporated herein has been omitted for conciseness.

A base station according to an embodiment of the present invention also performs scheduling based on the full-rate transition technique or the limited-rate transition technique described above. Therefore, the base station controls a reverse data rate of a mobile station by transmitting the scheduling result to the mobile station. In the following description of embodiments of the present invention, rate control information transmitted from a base station to a mobile station in the full-rate transition technique will be referred to as “grant message” and rate control information transmitted from a base station to a mobile station in the limited-rate transition technique will be referred to as “rate control information,” for convenience. The mobile station continuously controls its data rate according to the grant message or rate control information received from the base station.

In a general mobile communication system, a relationship between a data rate and TPR of a reverse traffic channel is previously known by a mobile station and a base station through a table. Therefore, controlling a data rate of a mobile station is substantially equivalent to controlling TPR of a mobile station. In other words, controlling a reverse data rate is equivalent to controlling TPR. Herein, a description of the present invention will be made with reference to the operation of controlling a reverse data rate. Therefore, a reverse rate control method proposed in the present invention can also be applied to a mobile communication system, which controls TPR of a mobile station instead of controlling a reverse data rate of the mobile station.

A reverse rate control method proposed in the present invention gives precedence to a grant message or rate control information received from a particular base station through a signaling message, in determining a reverse data rate. The former method can be used for changing a data rate in a wider scope, and can be referred to as an “aggressive reverse rate decision method.” The latter method can be used for changing a data rate in a narrower scope, and can be referred to as a “stable reverse rate decision method.”

Herein, the base station controls a reverse data rate using a signaling message according to an embodiment of the present invention. In the following description, the signaling message according to an embodiment of the present invention will be referred to as a “primary grant precedence indicator.” The primary grant precedence indicator according to an embodiment of the present invention is a signaling message and can be referred to as “PRIMARY_GRANT_PRECEDENCE_IND,” “GRANT_PRECEDENCE_IND” “PRIMARY_RC_PRECEDENCE_IND” (a precedence in Rate Control Command) or “PRIMARY_NB_PRECEDENCE_IND” according to system characteristics. The primary grant precedence indicator is information indicating whether a mobile station will give precedence to a grant message or rate control information in determining a reverse data rate. For convenience, the present invention will be described with reference to the case where a mobile station gives precedence to a grant message in determining a reverse data rate. However, embodiments of the present invention can also be applied to the case where a mobile station gives precedence to rate control information in determining a reverse data rate. In addition, the present invention can also be applied to the case where a mobile station gives precedence to a primary base station (or Node B) precedence indicator (PRIMARY_NB_PRECEDENCE_IND). A description of the case where a mobile station gives precedence to a primary base station precedence indicator will be given with reference to a third embodiment of the present invention.

The primary grant precedence indicator applied to embodiments of the present invention is a message, which is transmitted from a base station to a mobile station during call setup or through a handoff message. Upon receiving the primary grant precedence indicator from the base station, the mobile station stores the received primary grant precedence indicator, and determines a data rate for reverse packet data according to the stored primary grant precedence indicator if it receives rate control information or grant messages from a plurality of base stations due to, for example, a handoff situation.

This method corresponds to a first embodiment of the present invention for determining a data rate of a mobile station. A description will now be made of an application rule of the primary grant precedence indicator applied to the first embodiment of the present invention.

If the primary grant precedence indicator is set to ‘1’, the mobile station preferentially applies information on a grant message in various rate information received from several base stations. If the primary grant precedence indicator is set to ‘1’, two or more grant messages are received from base stations, and the primary grant precedence indicator is of the type PRIMARY_GRANT_PRECEDENCE_IND, then the mobile station can preferentially apply information received a primary base station (BS) with which it has been continuously communicating. However, if only one grant message is received, the mobile station can use only the received grant message. Also, if the primary grant precedence indicator is of the type PRIMARY_GRANT_PRECEDENCE_IND, the mobile station can select a data rate in a grant message indicating the highest data rate among a plurality of grant messages. When the primary grant precedence indicator is set to ‘1’, the mobile station preferentially applies a grant message in determining a data rate for reverse packet data.

However, if the primary grant precedence indicator is set to ‘0’, the mobile station preferentially recognizes rate control information indicating the lowest data rate in rate control information received from a plurality of base stations. That is, when the primary grant precedence indicator is set to ‘0’, no grant message is used. However, when only grant messages are received from all base stations, the mobile station can select the lowest data rate in the received grant messages. Unlike this, however, when rate control information and a grant message are received together, the mobile station uses the rate control information. Also, when only rate control information is received, the mobile station can use the rate control information indicating the lowest data rate in the received rate control information.

A description will now be made of a method for determining, by a mobile station, its data rate according to an application rule of the primary grant precedence indicator.

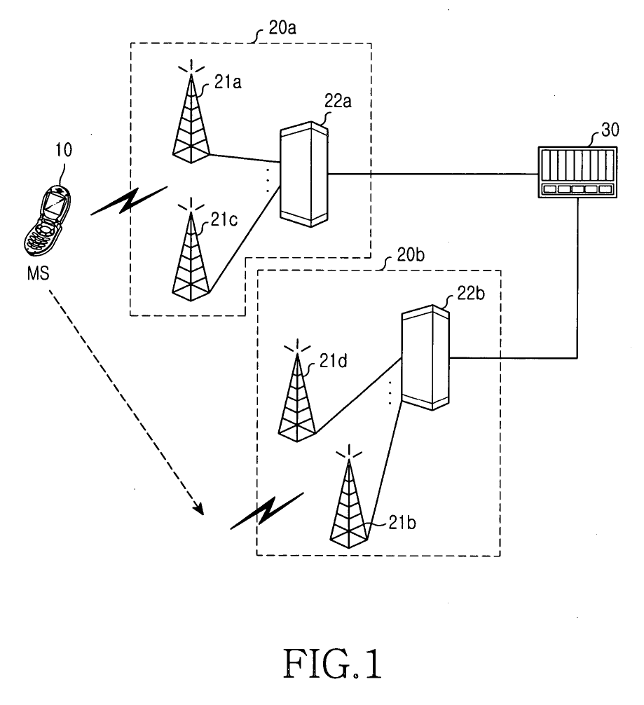

FIG. 1 is a diagram illustrating a configuration of a mobile communication system to which the present invention is applied. Referring to FIG. 1, a mobile communication system includes base transceiver stations (BTSs) 21a, 21b, 21c and 21d, and base station controllers (BSCs) 22a and 22b for controlling the base transceiver stations 21a, 21b, 21c and 21d. Here, the base transceiver stations 21a and 21c constitute a base station (BS) 20a, and the base transceiver stations 21b and 21d constitute a base station 20b. The base stations 20a and 20b perform communication with a mobile station (MS) 10 through wireless channels. According to embodiments of the present invention, the base stations 20a and 20b generate and transmit a primary grant precedence indicator, reverse rate control information, and a grant message to the mobile station 10 through a signaling message. The base stations 20a and 20b are connected to a switch and/or packet data service node 30 for data transmission/reception.

It is assumed herein that the mobile station 10 is performing handoff between the first base station 20a and the second base station 20b. In FIG. 1, a dotted line originating from the mobile station 10 represents handoff from the first base station 20a to the second base station 20b. In this state, the mobile station 10 receives rate control information or grant messages from both of the two base stations 20a and 20b. The first base station 20a is a primary base station (or source base station) for the mobile station 10. Here, the “primary base station” refers to a base station with which the mobile station 10 has been continuously communicating, or a base station having the best channel environment to the mobile station 10 among the two base stations.

For example, the first base station 20a, a primary base station, performs rate control on the mobile station 10 using the full-rate transition technique, and the second base station 20b, a target base station, perform rate control on the mobile station 10 using the limited-rate transition technique. Therefore, the mobile station 10 receives a grant message from the first base station 20a as reverse rate information, and receives rate control information from the second base station 20b as reverse rate information.

It is assumed herein that a set of data rates available for the mobile station 10 includes 9.6 Kbps, 19.2 Kbps, 38.4 Kbps, 76.8 Kbps, 153.6 Kbps, and 307.2 Kbps. Further, it is assumed that a current data rate of the mobile station 10 is 76.8 Kbps, and the mobile station 10 has received a grant message of “grant=307.2 Kbps” from the first base station 20a as reverse rate information, and has received rate control information of an Up command from the second base station 20b as reverse rate information. The grant message of “grant=307.2 Kbps” received from the first base station 20a means that the first base station 20a grants the mobile station 10 a data rate of 307.2 Kbps. The rate control information of an Up command received from the second base station 20b means that the second base station 20b grants the mobile station 10 a data rate of 153.6 Kbps.

When different reverse data rates are assigned to a mobile station based on different rate transition techniques as stated above, the mobile station determines a reverse data rate according to an application rule of a primary grant precedence indicator according to the present invention. A description will now be made of a method for determining a reverse data rate according to the primary grant precedence indicator. In this state, if the primary grant precedence indicator is set to ‘1’, it means that the mobile station 10 should always give precedence to a grant message received from the first base station 20a. Therefore, the mobile station 10 finally determines that the data rate of 307.2 Kbps is granted, in determining its data rate.

In contrast, if the primary grant precedence indicator is set to ‘0’, it means that the mobile station 10 should use rate control information. In this case, if there are a plurality of pieces of rate control information, the mobile station is allowed to preferentially recognize the rate control information indicating the lowest data rate among the received of rate control information. Alternatively, the mobile station may select the rate control information indicating the highest data rate, and may determine a reverse data rate using the largest number of pieces of rate control information. In this case, therefore, the mobile station 10 finally determines that the data rate of 153.6 Kbps is granted, in determining a data rate for reverse packet data.

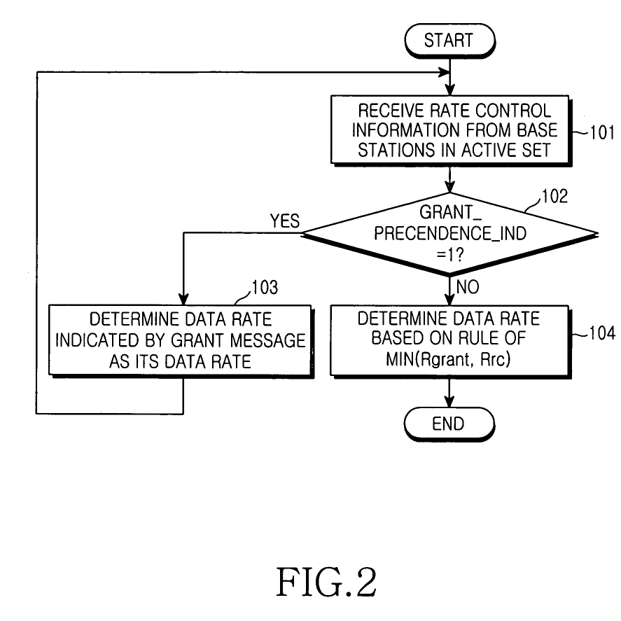

FIG. 2 is a flowchart illustrating a procedure for determining a reverse data rate by a mobile station in a handoff state according to a first embodiment of the present invention. Referring to FIG. 2, in step 101, a mobile station receives rate control information from base stations included in its active set. Here, the rate control information can be a grant message or rate control information according to whether a base station uses the full-rate transition technique or the limited-rate transition technique.

In step 102, the mobile station determines whether a primary grant precedence indicator received from a base station during call setup or in process of receiving a handoff message is set to ‘1’ or ‘0’. If it is determined in step 102 that the primary grant precedence indicator is set to ‘1’, the mobile station proceeds to step 103. In step 103, the mobile station gives precedence to a grant message, and determines a data rate indicated by the grant message as its data rate. If the number of grant messages received is two or more, the mobile station can select a grant message indicating the highest data rate or a grant message received from a primary base station.

However, if it is determined in step 102 that the primary grant precedence indicator is set to ‘0’, the mobile station proceeds to step 104. In step 104, the mobile station determines its data rate using a rule of MIN(Rgrant, Rrc). Here, MIN(Rgrant, Rrc) represents the minimum value between Rgrant and Rrc. Rgrant denotes a data rate indicated by a grant message and Rrc denotes a data rate granted by rate control information. For example, if a current data rate of the mobile station is 76.8 Kbps and received rate control information includes an Up command, the Rrc becomes 153.6 Kbps.

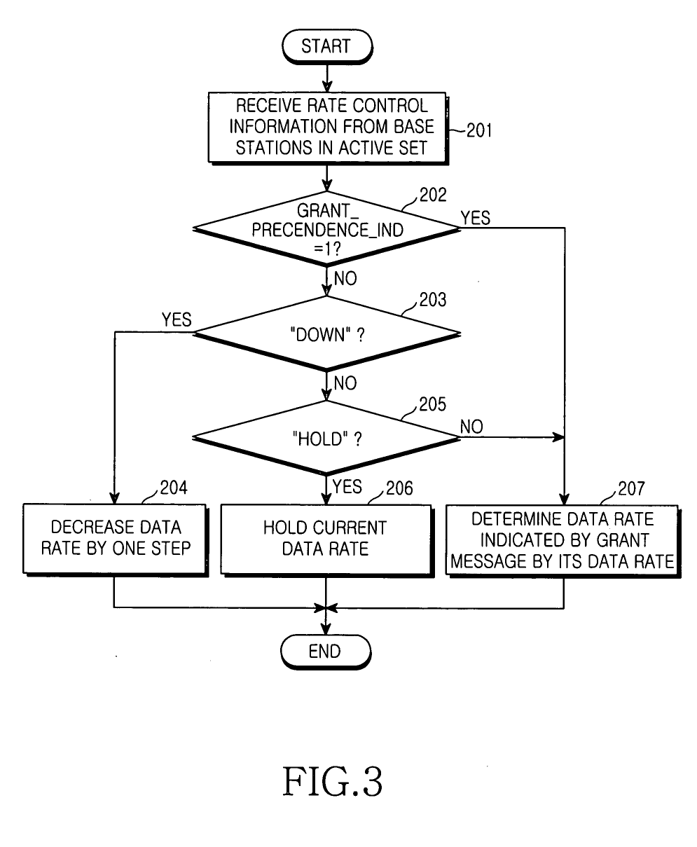

FIG. 3 is a flowchart illustrating a method for determining a data rate of a mobile station according to a second embodiment of the present invention. A description will first be made of an application rule of a primary grant precedence indicator applied to a second embodiment of the present invention. If the primary grant precedence indicator is set to ‘1’, the mobile station gives precedence to a grant message in various rate control information received from several base stations. However, in the case where the primary grant precedence indicator is set to ‘0’, if the rate control information received from the base stations includes a Down command, the mobile station decreases its data rate according to the Down command. If the received rate control information includes a Hold command rather than the Down command, the mobile station holds its data rate according to the Hold command. If neither the Down command nor the Hold command is received from the base stations, the mobile station controls it data rate according to a grant message or Up command.

A method for determining, by a mobile station, its data rate according to an application rule of a GRANT_PRECEDENCE_IND message for a second embodiment of the present invention will now be described with reference to the accompanying drawings.

Referring back to FIG. 1, the mobile station 10 is performing handoff between the first base station 20a and the second base station 20b, and separately receives rate control information from the two base stations 20a and 20b. The first base station 20a is considered a primary base station for the mobile station 10, while the second base station 206 is considered a target base station.

The primary base station 20a performs rate control on the mobile station 10 using the full-rate transition technique, and the target base station 20b performs rate control on the mobile station 10 using the limited-rate transition technique. Therefore, the mobile station 10 receives a grant message from the first base station 20a as reverse rate information, and receives rate control information from the second base station 20b as reverse rate information.

It is assumed herein that a set of data rates available for the mobile station 10 includes 9.6 Kbps, 19.2 Kbps, 38.4 Kbps, 76.8 Kbps, 153.6 Kbps, and 307.2 Kbps. For example, it is assumed that a current data rate of the mobile station 10 is 76.8 Kbps, the mobile station 10 has received a grant message of “grant=307.2 Kbps” from the first base station 20a, and has received rate control information of an Up command from the second base station 20b. The grant message of “grant=307.2 Kbps” received from the first base station 20a means that the first base station 20a grants the mobile station 10 a data rate of 307.2 Kbps. The rate control information of an Up command received from the second base station 20b means that the second base station 20b grants the mobile station 10 a data rate of 153.6 Kbps.

In this state, if the primary grant precedence indicator is set to ‘1’ according to an application rule of the primary grant precedence indicator, it means that the mobile station 10 will give precedence to a grant message received from the first base station 20a. Therefore, the mobile station 10 finally determines that the data rate of 307.2 Kbps is granted, in determining its data rate. In contrast, in the case where the primary grant precedence indicator is set to ‘0’, if neither a Down command nor a Hold command is included in the rate control information received from a plurality of base stations, the mobile station 10 controls its data rate according to the grant message. Therefore, the mobile station 10 finally determines that the data rate of 307.3 Kbps is granted, in determining a data rate for reverse packet data.

Referring to FIG. 3, in step 201, a mobile station receives reverse rate information from base stations included in its active set. Here, the reverse rate information can be a grant message or rate control information according to whether a base station uses the full-rate transition technique or the limited-rate transition technique.

In step 202, the mobile station determines whether a primary grant precedence indicator received from a base station during call setup or in a process of receiving a handoff message is set to ‘1’ or ‘0’. If it is determined in step 202 that the primary grant precedence indicator is set to ‘1’, the mobile station proceeds to step 207, where the mobile station determines its data rate as indicated by the grant message. Otherwise, the mobile station proceeds to step 203, where the mobile station determines whether the rate control information received from a plurality of base stations includes a Down command. If the rate control information received from a plurality of base stations includes a Down command, the mobile station proceeds to step 204 where it determines its data rate according to the Down command. That is, the mobile station decreases its data rate by one step from the current data rate.

However, if it is determined in step 203 that the rate control information received from a plurality of base stations does not include a Down command, the mobile station proceeds to step 205, where the mobile station determines whether the rate control information received from a plurality of base stations includes a Hold command. If the rate control information received from a plurality of base stations includes a Hold command, the mobile station proceeds to step 206 where it holds the current data rate according to the Hold command in determining its data rate. However, if it is determined in step 205 that the received rate control information does not include a Hold command, the mobile station proceeds to step 207, where the mobile station determines its data rate as indicated by the grant message.

Next, a third embodiment of the present invention will be described. A description will first be of an application rule of a primary grant precedence indicator PRIMARY_NB_PRECEDENCE_IND applied to the third embodiment of the present invention.

If a primary grant precedence indicator received from a base station is set to ‘1’, a mobile station gives precedence to scheduling information from a primary base station in reverse rate information received from a plurality of base stations. In the case where the primary grant precedence indicator is set to ‘0’, if rate control information received from several base stations includes a Down command, the mobile station decreases its data rate by one step from the current data rate. However, if the rate control information received from several base stations does not include a Down command, the mobile station determines its data rate according to the scheduling information from the primary base station.

A detailed method for determining, by a mobile station, its data rate according to an application rule of a primary grant precedence indicator for the third embodiment of the present invention will now be described with reference to FIG. 1, by way of example.

It is assumed herein that the mobile station 10 is performing handoff between the first base station 20a and the second base station 20b. Therefore, the mobile station separately receives rate information form the two base stations 20a and 20b. The first base station 20a is considered a primary base station for the mobile station 10; i.e., a base station with which the mobile station 10 has been continuously communicating, or a base station having the best channel environment to the mobile station 10 among the two base stations 20a and 20b.

Reverse rate information received from a base station can be separately transmitted to mobile stations located in the base station's area or commonly transmitted to the mobile stations in the base station's area according to a scheduling algorithm. Therefore, when the primary base station 20a desires to abruptly increase a data rate of the mobile station 10, it can control the data rate of the mobile station 10 using the full-rate transition technique. In other cases, the primary base station 20a can control a data rate of the mobile station 10 using the limited-rate transition technique. The second base station 20b, a non-primary base station or a target base station, can be set such that it can control a data rate of the mobile station 10 using only the limited-rate transition technique. In this case, the target base station 20b can set “Down/Don't Care” information for rate control because it cannot correctly perform scheduling on the mobile station 10.

If the rate control information transmitted from the target base station 20b is “Down” information, the mobile station 10 is ordered to decrease its data rate by one step. However, if the rate control information transmitted from the target base station 20b is “Don't Care” information, the mobile station 10 is ordered to control its data rate according to rate information transmitted from another base station. Therefore, the mobile station 10 receives a grant message or rate control information from the primary base station 20a as rate information, and receives “Down/Don't Care” information from the target base station 20b as rate information. It is assumed herein that a set of data rates available for the mobile station 10 includes 9.6 Kbps, 19.2 Kbps, 38.4 Kbps, 76.8 Kbps, 153.6 Kbps, and 307.2 Kbps, and a current data rate of the mobile station 10 is 76.8 Kbps.

Further, it is assumed that the mobile station 10 receives rate information of “grant=307.2 Kbps” from the primary base station 20a and receives rate control information of a Down command from the target base station 20b. The rate information of “grant=307.2 Kbps” received from the primary base station 20a means that the primary base station 20a grants the mobile station 10 a data rate of 307.2 Kbps. The rate control information of a “Down” command received from the target base station 20b means that the target base station 20b grants the mobile station 10 a data rate of 38.4 Kbps.

As described above, when rate information based on different rate transition techniques and different rate values are received from different base stations according to an application rule of the primary grant precedence indicator applied to the third embodiment of the present invention, the mobile station can determine its data rate according to a value of the primary grant precedence indicator. For example, if the primary grant precedence indicator is set to ‘1’, it means that the mobile station 10 always gives precedence to scheduling information from the first base station 20a. Therefore, the mobile station 10 finally determines that the data rate of 307.2 Kbps is granted, in determining its data rate. In contrast, if the primary grant precedence indicator is set to ‘0’, the mobile station 10 controls its data rate using a Down command in rate control information received from several base stations. That is, the mobile station 10 decreases its data rate by one step from the current data rate as a next data rate for reverse packet data. Therefore, the mobile station 10 finally determines that the data rate of 38.4 Kbps is granted, in determining its data rate.

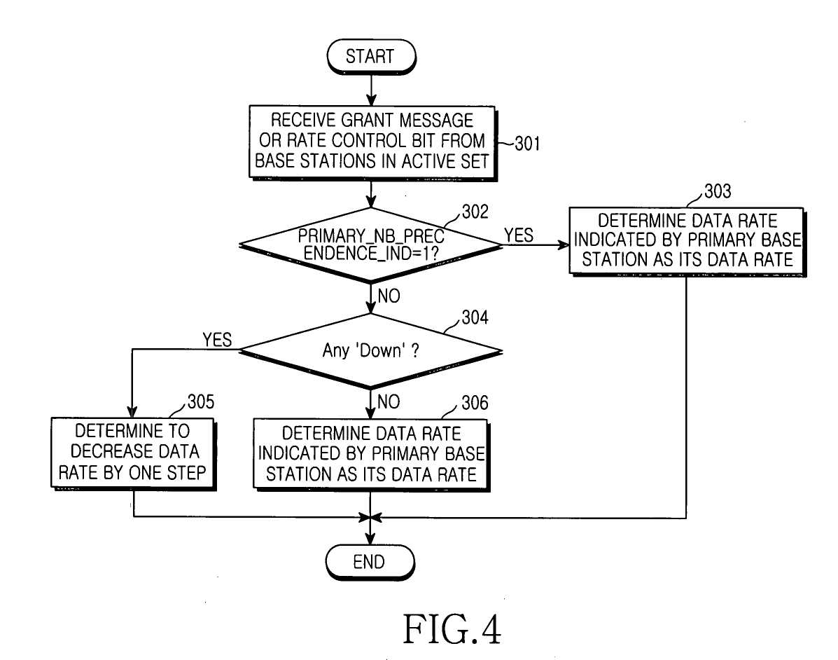

FIG. 4 is a flowchart illustrating a method for determining a reverse data rate of a mobile station in a handoff state according to a third embodiment of the present invention. Referring to FIG. 4, in step 301, a mobile station in a handoff state receives rate information from several base stations in its active set. The rate information includes a grant message or rate control information. Rate information to be used by the mobile station in the received rate information is determined according to whether a base station uses the full-rate transition technique or the limited-rate transition technique.

In step 302, the mobile station determines whether a primary base station precedence indicator is set to ‘1’ or ‘0’. If it is determined in step 302 that the primary base station precedence indicator is set to ‘1’, the mobile station proceeds to step 303, in which the mobile station gives precedence to a grant message or rate control information, which is rate information received from the primary base station. That is, if the rate information received from the primary base station is a grant message, the mobile station regards a data rate indicated by the grant message as its data rate for reverse packet data. However, if the rate information received from the primary base station is rate control information, the mobile station determines its data rate for reverse packet data according to the rate control information received from the primary base station. That is, if the rate control information received from the primary base station includes an Up command, the mobile station increases its data rate. If the rate control information received from the primary base station includes a Down command, the mobile station decrease its data rate. If the rate control information received from the primary base station includes a Hold command, the mobile station holds the current data rate. In conclusion, the mobile station determines its data rate using a grant message or rate control information received in the message from the primary base station (or Node B (NB)).

However, if it is determined in step 302 that the primary base station precedence indicator is set to ‘0’, the mobile station proceeds to step 304. In step 304, the mobile station determines whether rate control information received from several base stations includes a Down command. If it is determined in step 304 that the rate control information received from several base stations includes a Down command, the mobile station proceeds to step 305, where the mobile station uses the Down command in determining its data rate, i.e., the mobile station decreases its data rate by one step from the current data rate. However, if it is determined in step 304 that the rate control information received from several base stations does not include a Down command, the mobile station proceeds to step 306. In step 306, the mobile station regards a reverse data rate indicated by a grant message or a data rate adjusted by rate control information, both the grant message and rate control information being received from the primary base station, as its data rate, in determining a data rate thereof. In conclusion, the mobile station determines its data rate based on a grant message or rate control information received from the primary base station.

A description will now be made of a method for indicating, by a particular base station, assignment of a primary base station precedence indicator for a mobile station in a handoff state. In the following description, the information indicating assignment of a primary base station precedence indicator will be referred to as “grant precedence information.”

In the present invention, a particular base station informs a neighbor base station whether the primary base station precedence indicator is set, so that it can consider a mobile station that regards a corresponding base station among mobile stations for which the primary base station precedence indicators are set to ‘1’ as a non-primary base station, while performing scheduling or transmitting control information. In a Universal Mobile Telecommunications System (UMTS) system, the corresponding information can be transmitted through a Node B Application Part (NBAP) signaling message in an Iub interface.

A description will now be made of an example of using the grant precedence information. An environment described below corresponds to an environment where a mobile station operates according to an embodiment of the present invention in a system where a particular base station, i.e., a non-primary base station, transmits a dedicated rate control bit to each mobile station. In this case, transmitting rate control information even to a mobile station for which a primary base station precedence indicator is set to ‘1’ is meaningless. Therefore, the non-primary base station determines whether to transmit rate control information using information on a primary base station precedence indicator assigned to each mobile station in the primary base station.

When controlling a reverse data rate of a mobile station in a handoff state, a base station first determines whether it is defined as a primary base station or a non-primary base station. If it is determined that the base station is defined as a non-primary base station for the mobile station in a handoff state, the base station determines whether the mobile station in a handoff state is a mobile station for which a primary base station precedence indicator is set to ‘1’ using grant precedence information received from another base station. If it is determined that the base station is defined as a non-primary base station and the primary base station precedence indicator for the mobile station in a handoff state is set to ‘1’, the base station dose not transmit rate control information to the mobile station. However, if it is determined that the base station is defined as a non-primary base station and the primary base station precedence indicator for the mobile station in handoff state is set to ‘0’, the base station transmits rate control information to the mobile station.

The GRANT_PRECEDENCE_IND information can be transmitted through a signaling layer, and a method for transmitting the GRANT_PRECEDENCE_IND information through the signaling layer will be described by way of example. In the case of the UMTS system, the GRANT_PRECEDENCE_IND information can be transmitted through a radio resource control (RRC) signaling message in a radio network controller (RNC). The GRANT_PRECEDENCE_IND information is transmitted by modifying the existing Extended System Parameters Message (ESPM), Extended Channel Assignment Message (ECAM), MC-RR (Multi Carrier Radio Resource) Parameters Message (MCRRPM), and Universal Handoff Direction Message (UHDM). Alternatively, the GRANT_PRECEDENCE_IND information is transmitted by defining a new order message of Grant Precedence Order.

Table 1 illustrates a format of the ESPM modified to transmit the GRANT_PRECEDENCE_IND information.

TABLE 1

| Field | Length (bits) |
|---|---|
| REV_PDCH_SUPPORTED | 0 or 1 |
| REV_PDCH_PARAMS_INCL | 0 or 1 |
| [...] | |
| REV_PDCH_SOFT_HANDOFF_RESET_IND | 0 or 1 |
| REV_PDCH_GRANT_PRECEDENCE_IND | 0 or 1 |

ESPM illustrated in Table 1 includes a 1-bit reverse packet data channel grant precedence indicator (REV_PDCH_GRANT_PRECEDENCE_IND) field added to the conventional ESPM. The REV_PDCH_GRANT_PRECEDENCE_IND field is included only when a reverse packet data channel parameter inclusion (REV_PDCH_PARAMS_INCL) field is included and has a value of ‘1’, and when it is set to ‘1’, it means that a grant message always takes precedence over rate control information for all mobile stations in a coverage area.

Table 2 illustrates a format of ECAM modified to transmit the GRANT_PRECEDENCE_IND information.

TABLE 2

| Field | Length (bits) |
|---|---|
| REV_PDCH_PARAMS_INCL | 0 or 1 |
| [...] | |
| REV_PDCH_SOFT_HANDOFF_RESET_IND | 0 or 1 |
| REV_PDCH_GRANT_PRECEDENCE_IND | 0 or 1 |
| [...] | |

When a packet data traffic channel is assigned using the conventional ECAM (ASSIGN_MODE=‘101’), the ECAM includes a 1-bit REV_PDCH_GRANT_PRECEDENCE_IND field to transmit the GRANT_PRECEDENCE_IND information. The REV_PDCH_GRANT_PRECEDENCE_IND field is included only when the REV_PDCH_PARAMS_INCL field is included and has a value of ‘1’, and when it is set to ‘1’, it means that a grant message always takes precedence over rate control information for a mobile station assigned a channel.

Table 3 illustrates a format of MCRRPM modified to transmit the GRANT_PRECEDENCE_IND information.

TABLE 3

| Field | Length (bits) |
|---|---|
| REV_PDCH_SUPPORTED | 0 or 1 |
| REV_PDCH_PARAMS_INCL | 0 or 1 |
| [...] | |
| REV_PDCH_SOFT_HANDOFF_RESET_IND | 0 or 1 |
| REV_PDCH_GRANT_PRECEDENCE_IND | 0 or 1 |

In Table 3, MCRRPM modified to transmit the GRANT_PRECEDENCE_IND information, like the ESPM, includes a 1-bit REV_PDCH_GRANT_PRECEDENCE_IND field added to the conventional MCRRPM.

Table 4 illustrates a format of UHDM modified to transmit the GRANT_PRECEDENCE_IND information.

TABLE 4

| Field | Length (bits) |
|---|---|
| REV_PDCH_PARAMS_INCL | 0 or 1 |
| [...] | |
| REV_PDCH_SOFT_HANDOFF_RESET_IND | 0 or 1 |
| REV_PDCH_GRANT_PRECEDENCE_IND | 0 or 1 |
| [...] | |

In Table 4, when a packet data traffic channel is set up using the conventional UHDM (CH_IND=‘000’, EXT_CH_IND is not ‘00000’, ‘00111’, ‘10111’˜11111’), UHDM modified to transmit the GRANT_PRECEDENCE_IND information includes a 1-bit REV_PDCH_GRANT_PRECEDENCE_IND field to transmit the GRANT_PRECEDENCE_IND information.

A mobile station receiving a message including the GRANT_PRECEDENCE_IND field stores a value of the received GRANT_PRECEDENCE_IND field in GRANT_PRECEDENCE_INDs, a shared parameter between a signaling layer and a medium access control (MAC) layer, and applies the stored value to an operation of the MAC layer.

Alternatively, the GRANT_PRECEDENCE_IND information can also be transmitted using other messages except the ESPM, ECAM, MCRRPM and UHDM. Also, the GRANT_PRECEDENCE_IND information can be transmitted by defining a new message instead of modifying the conventional message.

Table 5 illustrates a format of a Grant Precedence Order message, an Order Message newly defined to transmit the GRANT_PRECEDENCE_IND information.

TABLE 5

| | | | Order | | Additional | | |
|---|---|---|---|---|---|---|---|
| f-csch | f-dsch | Order Code, | Qualification Code, | ACTION_TIME | Fields other | | |
| Order | Order | ORDER (binary) | ORDQ (binary) | can be specified | than ORDQ | P_REV_IN_USE | Name/Function |
| Y | N | 100011 | 00000001 | N | Y | 11 | Mode Transition Order (indicates |
| | | | | | | | base station response to mobile |
| | | | | | | | station's request to operate in |
| | | | | | | | reduced slot cycle mode, see |
| | | | | | | | 3.7.4.10) |
| Y | Y | 100100 | 00000000 | Y | N | 11 | Grant Precedence Order |
| | | | | | | | (indicates a Grant precedes Rate |
| | | | | | | | Control Bit) |
| Y | Y | 100100 | 00000001 | Y | N | 11 | Grant Precedence Order |
| | | | | | | | (indicates a Grant does not |
| | | | | | | | precede Rate Control Bit) |

In Table 5, a base station can transmit an Order Message with order code=‘100100’ and Order Qualification Code (ORDQ)=‘00000000’ to inform that a grant message takes precedence over rate control information. Also, the base station can transmit an Order Message with order code=‘100100’ and ORDQ=‘00000001’ to inform that the grant message does not take precedence over rate control information.

A mobile station receiving the Order Message with order code=‘100100’ and ORDQ=‘00000000’ sets a value of GRANT_PRECEDENCE_INDs to ‘1’, and a mobile station receiving the Order Message with order code=‘100100’ and ORDQ=‘0000000l’ sets a value of GRANT_PRECEDENCE_INDs to ‘0’, and applies the results to an operation of the MAC layer.

As can be understood from the foregoing description, a mobile station in a handoff state combines rate control information transmitted previously from a plurality of base stations through signaling messages and determines its data rate according to the combination result. Therefore, the mobile station can obtain lower throughput, so that the base station can reduce a scheduling load and can efficiently control a reverse data rate.

While the invention has been shown and described with reference to a certain preferred embodiment thereof, it will be understood by those skilled in the art that various changes in form and details may be made therein without departing from the spirit and scope of the invention as defined by the appended claims.

1. A method for determining a data rate by a mobile station in a mobile communication system including a plurality of base stations communicating with the mobile station, comprising the steps of:
receiving rate control information from the base stations;
receiving precedence indicator information, wherein the precedence indicator information is information for giving precedence to a particular rate control information in the rate control information received from the base stations; and
determining a data rate according to the particular rate control information to which precedence is given by the precedence indicator information.

2. The method of claim 1, wherein the precedence indicator information is received from at least one of the plurality of base stations.

3. The method of claim 1, wherein the step of determining a data rate comprises giving precedence to rate control information set to grant precedence indicator information in rate control information received from the base stations, if rate control information representing precedence indication is received from a base station that performs scheduling using a full-rate transition technique.

4. The method of claim 1, wherein the step of determining a data rate comprises giving precedence to rate control information indicating a lowest data rate in rate control information received from the base stations, if rate control information not representing precedence indication is received from a base station that performs scheduling using a limited-rate transition technique.

5. The method of claim 1, wherein the rate control information received from the base stations includes a grant command or a rate control command.

6. The method of claim 1, wherein the precedence indicator information includes a grant precedence indicator.

7. The method of claim 1, wherein the precedence indicator information includes a rate control precedence indicator.

8. The method of claim 1, wherein if the precedence indicator information is set to ‘1’, the mobile station determines a data rate indicated by a grant command from the base stations as its data rate.

9. The method of claim 1, wherein if the precedence indicator information is set to ‘0’, the mobile station determines, as its data rate, a lowest data rate among data rates granted by a grant command or a rate control command from the base stations.

10. The method of claim 1, wherein if the precedence indicator information is set to ‘0’ and a rate control command is a down command, the mobile station determines a data rate determined by the down command as its data rate.

11. The method of claim 3, wherein the step of determining a data rate comprises giving precedence to rate control information indicating a lowest data rate in rate control information received from the base stations, if rate control information not representing precedence indication is received from a base station that performs scheduling using a limited-rate technique.

12. A mobile communication system for determining a reverse data rate, comprising:
a plurality of base stations for transmitting rate control information according to a scheduling result; and
a mobile station for receiving the rate control information transmitted from the base stations, and determining its data rate according to precedence indicator information, wherein the precedence indicator information is information for giving precedence to a particular rate control information in the rate control information received from the base stations.

13. The mobile communication system of claim 12, wherein the mobile station determines a data rate indicated by rate control information representing precedence indication as its data rate, if rate control information in which the precedence indicator information is set to a grant precedence indicator representing precedence indication is received from a base station that performs scheduling using a full-rate transition technique.

14. The mobile communication system of claim 12, wherein the mobile station determines a data rate by giving precedence to rate control information indicating a lowest data rate in rate control information received from the base stations, if rate control information in which the precedence indicator information is set to a rate control bit not representing precedence indication is received from a base station that performs scheduling using a limited-rate transition technique.

15. The mobile communication system of claim 12, wherein the rate control information received from the base stations includes a grant command or a rate control command.

16. The mobile communication system of claim 12, wherein the precedence indicator information includes a grant precedence indicator.

17. The mobile communication system of claim 12, wherein the precedence indicator information includes a rate control precedence indicator.

18. The mobile communication system of claim 12, wherein if the precedence indicator information is set to ‘0’ and a rate control command is a down command, the mobile station determines a data rate determined by the down command as its data rate.

19. The mobile communication system of claim 13, wherein the mobile station determines a data rate by giving precedence to rate control information indicating a lowest data rate in rate control information received from the base stations, if rate control information in which the precedence indicator information is set to a rate control bit not representing precedence indication is received from a base station that performs scheduling using a limited-rate transition technique.
